(19) United States
(12) Patent Application Publication
(10) Pub. No.: US 2022/0167794 A1
(43) Pub. Date: Jun. 2, 2022

(54) Frying Oil Filtration Apparatus

(71) Applicant: Raymond Patterson, Beaumont, TX (US)

(72) Inventor: Raymond Patterson, Beaumont, TX (US)

(21) Appl. No.: 17/108,087

(22) Filed: Dec. 1, 2020

(51) Int. Cl. A47J 37/12

(52) U.S. Cl. CPC A47J 37/1223; A47J 37/1266

(57) ABSTRACT

A frying oil filtration apparatus for safely recycling cooking oil includes a housing having a base portion and a cylindrical sidewall with a hose aperture extending therethrough. A vacuum hose is coupled to the hose aperture to pull used cooking oil through a filter coupled to the housing. A collection pan coupled within the sidewall draws the oil through a vacuum pump to a one-way valve. A reservoir has a reservoir bottom, a reservoir sidewall, and a reservoir rim. The reservoir bottom has a fill aperture extending therethrough and the reservoir sidewall conforms to a reservoir cavity of the filter to be selectively engageable within the filter. The fill aperture is in fluid communication with the one-way valve to allow the reservoir to fill with filtered oil. The reservoir has a pair of reservoir handles coupled to the reservoir rim.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM.

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to oil filtration devices and more particularly pertains to a new oil filtration device for safely recycling cooking oil. The present invention includes an integrated vacuum pump as well as a removable reservoir for filtered oil.

### (2) Description of Related Art including information disclosed under 37 CFR 1.97 and 1.98

The prior art relates to oil filtration devices. Known devices typically do not include an integrated vacuum pump. Known devices with a pump lack a filter that surrounds a removable reservoir and rather have an output hose to immediately dispense filtered oil.

### BRIEF SUMMARY OF THE INVENTION

An embodiment of the disclosure meets the needs presented above by generally comprising a housing having a base portion and a cylindrical sidewall extending from the base portion. The sidewall has a hose aperture extending therethrough. A vacuum hose is coupled to the hose aperture. A filter is coupled to the housing. The filter conforms to the cylindrical sidewall and has a reservoir cavity. A collection pan is coupled to the housing within the sidewall atop the base portion and beneath the filter. The collection pan has a release aperture. A vacuum pump is coupled to the housing within the base portion. The vacuum pump has a pump intake in fluid communication with the release aperture of the collection pan to create suction through the filter and the hose aperture. The vacuum pump has a pump output hose extending above the collection pan. The vacuum pump has a power cord extending through the housing. A controller is coupled to the housing and is in operational communication with the vacuum pump. A one-way valve is coupled to the housing. The one-way valve is coupled adjacent the reservoir cavity of the filter and is in fluid communication with the pump output hose of the vacuum pump. A reservoir has a reservoir bottom, a reservoir sidewall, and a reservoir rim. The reservoir bottom has a fill aperture extending therethrough and the reservoir sidewall conforms to the reservoir cavity of the filter to be selectively engageable within the filter. The fill aperture is in fluid communication with the one-way valve to allow the reservoir to fill with filtered oil. The reservoir has a pair of reservoir handles coupled to the reservoir rim.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front elevation view of a frying oil filtration apparatus according to an embodiment of the disclosure.

FIG. 2 is a side elevation view of an embodiment of the disclosure.

FIG. 3 is a bottom plan view of an embodiment of the disclosure.

FIG. 4 is a rear elevation view of an embodiment of the disclosure.

FIG. 5 is a cross-sectional view of an embodiment of the disclosure along the line 5-5 of FIG. 4.

### DETAILED DESCRIPTION OF THE INVENTION

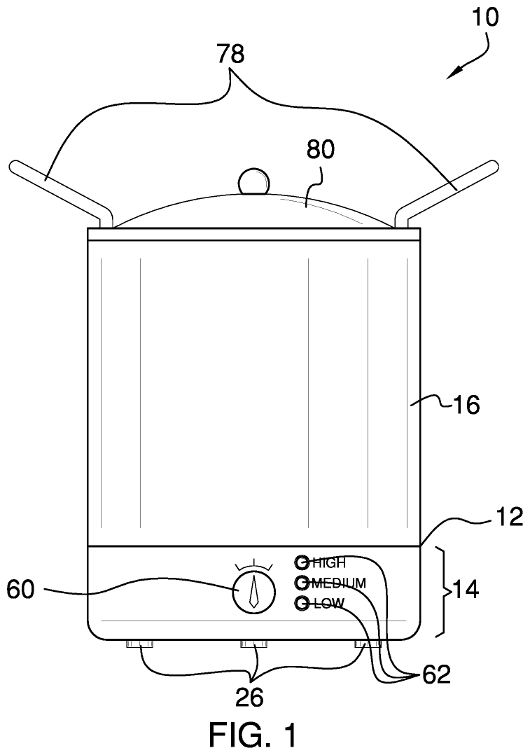

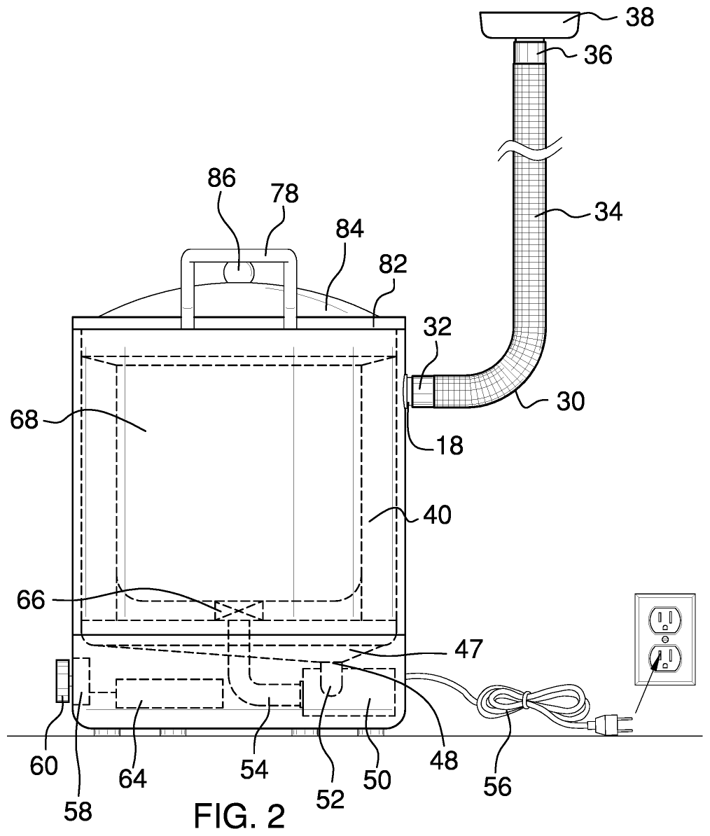

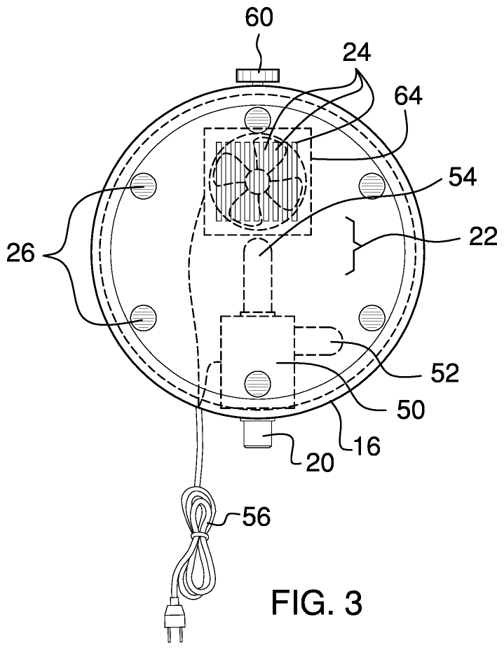

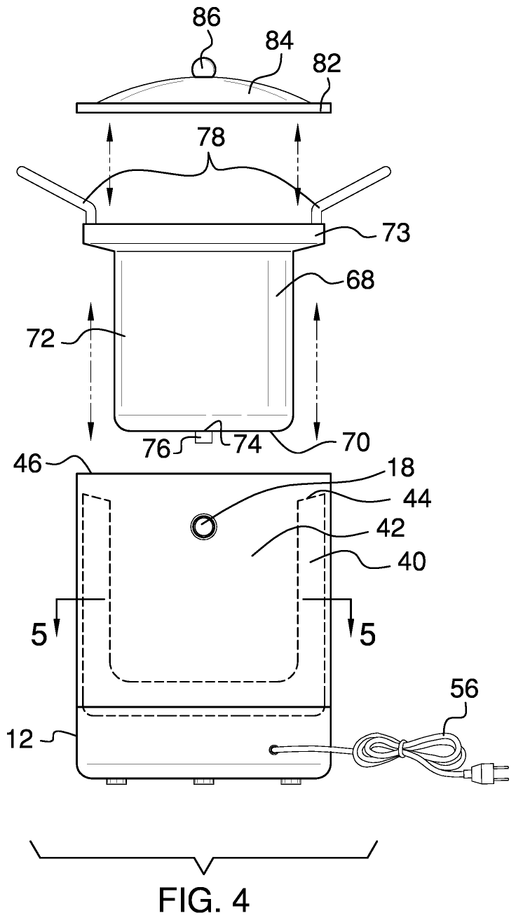

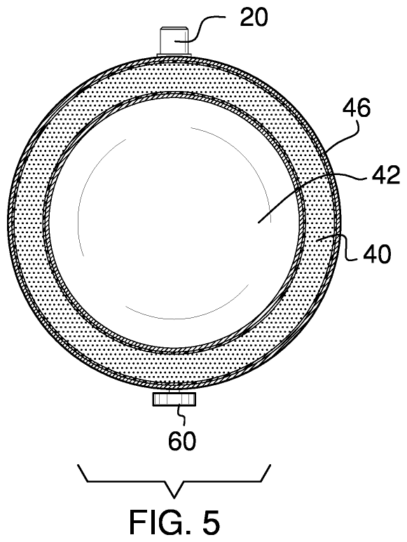

With reference now to the drawings, and in particular to FIGS. 1 through 5 thereof, a new oil filtration device embodying the principles and concepts of an embodiment of the disclosure and generally designated by the reference numeral 10 will be described.

As best illustrated in FIGS. 1 through 5, the frying oil filtration apparatus 10 generally comprises a housing 12 having a base portion 14 and a cylindrical sidewall 16 extending from the base portion 12. The sidewall 16 has a hose aperture 18 extending therethrough and may have a cylindrical coupler 20 extending around the hose aperture 18. An underside 22 of the base portion may have a plurality of vent slots 24 extending therethrough. A plurality of feet 26 is coupled to the housing 12. Each foot 26 is coupled to the underside 22 of the base portion and may be evenly spaced around a perimeter 28 of the base portion.

A vacuum hose 30 is coupled to the housing 12. The vacuum hose 30 is selectively engageable with the coupler 20 to be in fluid communication with the hose aperture 18. The vacuum hose 30 may include a rigid proximal end 32 to engage the coupler 20, a flexible body portion 34, and a rigid distal end 36 to receive a hose attachment 38. The hose attachment 38 is configured to facilitate removal of cooking oil from a pot, pan, or fryer.

A filter 40 is coupled to the housing 12. The filter 40 conforms to the cylindrical sidewall 16 and has a reservoir cavity 42. The filter may have an upper filter perimeter 44 disposed below a sidewall perimeter 46 of the cylindrical sidewall 16. The upper filter perimeter 44 may be angled. The filter 40 is configured to remove particulate from the cooking oil to allow reuse.

A collection pan 47 is coupled to the housing 12. The collection pan 47 is coupled within the sidewall 16 atop the base portion 14 and beneath the filter, the collection pan 47 has a release aperture 48 and is funnel-shaped to direct the cooking oil towards the release aperture 48. The release aperture 48 may be positioned off-center within the base portion 14.

A vacuum pump 50 is coupled to the housing 12 within the base portion 14. The vacuum pump 50 has a pump intake 52 in fluid communication with the release aperture 48 of the collection pan to create suction through the filter 40 and the hose aperture 18 to draw in the cooking oil. The vacuum pump 50 has a pump output hose 54 extending above the collection pan 47. The off-center positioning of the release aperture 48 allows the vacuum pump 50 to be positioned and accommodate the pump output hose 54 to extend centrally. The vacuum pump 50 has a power cord 56 extending through the housing 12.

A controller 58 is coupled to the housing 12 and in operational communication with the vacuum pump 50. The controller 58 may have an adjustment knob 60 and a plurality of indicator lights 62 coupled to the base portion 14 of the housing. The adjustment knob 60 controls the speed at which the cooking oil is drawn through the vacuum hose 30 with the plurality of indicator lights 62 showing the currently selected speed. A cooling fan 64 may be coupled to the housing 12 within the base portion 14 adjacent the plurality of vent slots 24. The cooling fan 64 is in operational communication with the vacuum pump 50 to receive power as well as to activate simultaneously in order to prevent the vacuum pump 50 from overheating.

A one-way valve 66 is coupled to the housing 12. The one-way valve 66 is coupled adjacent the reservoir cavity 42 of the filter and is in fluid communication with the pump output hose 54 of the vacuum pump.

A reservoir 68 has a reservoir bottom 70, a reservoir sidewall 72, and a reservoir rim 73. The reservoir bottom 70 has a fill aperture 74 extending therethrough and a nipple 76 extending around the fill aperture 74. The reservoir sidewall 72 conforms to the reservoir cavity 42 of the filter to be selectively engageable within the filter 40. Each of the reservoir cavity 42 and the reservoir sidewall may be cylindrical. The nipple 76 selectively engages the one-way valve 66 and the fill aperture 74 is in fluid communication with the one-way valve 66 to allow the reservoir 68 to fill with the filtered cooking oil from the vacuum pump 50. The reservoir 68 has a pair of reservoir handles 78 coupled to the reservoir rim 73 to allow for safe and easy removal of the reservoir 68 from the filter 40 and the housing 12. Each reservoir handle 78 may extend up and away from the reservoir rim 73. The reservoir rim 73 conforms to the upper filter perimeter 44 and extends up to the sidewall perimeter 46.

A cover 80 may be coupled to the reservoir 68. The cover 80 includes a cover perimeter 82, a concave cover body 84 coupled to the cover perimeter 82, and a cover knob 86 medially coupled to the cover body 84. The cover body 84 may be transparent in order to allow the user to see the level of filtered cooking oil within the reservoir 68. The cover perimeter 82 is selectively engageable with the reservoir rim 73.

In use, the hose attachment 38 is submerged in used cooking oil and the controller 58 is activated to draw the used cooking oil through the filter 40 and into the reservoir 68. Once complete, the reservoir 68 may be removed to pour the filtered cooking oil into a container for reuse.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded.

A reference to an element by the indefinite article “a” does not exclude the possibility that more than one of the element is present, unless the context clearly requires that there be only one of the elements.

I claim:

1. A frying oil filtration apparatus comprising:
a housing having a base portion and a cylindrical sidewall extending from the base portion, the sidewall having a hose aperture extending therethrough;
a vacuum hose coupled to the housing, the vacuum hose being coupled to the hose aperture;
a filter coupled to the housing, the filter conforming to the cylindrical sidewall and having a reservoir cavity;
a collection pan coupled to the housing, the collection pan being coupled within the sidewall atop the base portion and beneath the filter, the collection pan having a release aperture;
a vacuum pump coupled to the housing, the vacuum pump being coupled within the base portion, the vacuum pump having a pump intake in fluid communication with the release aperture of the collection pan to create suction through the filter and the hose aperture, the vacuum pump having a pump output hose extending above the collection pan, the vacuum pump having a power cord extending through the housing;
a controller coupled to the housing, the controller being in operational communication with the vacuum pump;
a one-way valve coupled to the housing, the one-way valve being coupled adjacent the reservoir cavity of the filter and being in fluid communication with the pump output hose of the vacuum pump; and
a reservoir, the reservoir having a reservoir bottom, a reservoir sidewall, and a reservoir rim, the reservoir bottom having a fill aperture extending therethrough, the reservoir sidewall conforming to the reservoir cavity of the filter to be selectively engageable within the filter, the fill aperture being in fluid communication with the one-way valve to allow the reservoir to fill with filtered oil, the reservoir having a pair of reservoir handles coupled to the reservoir rim.

2. The frying oil filtration apparatus of claim 1 further comprising the controller having an adjustment knob and a plurality of indicator lights coupled to the base portion of the housing.

3. The frying oil filtration apparatus of claim 1 further comprising a plurality of feet coupled to the housing, each foot being coupled to an underside of the base portion.

4. The frying oil filtration apparatus of claim 1 further comprising a cover coupled to the reservoir, the cover being selectively engageable with the reservoir rim.

5. The frying oil filtration apparatus of claim 4 further comprising the cover including a cover perimeter, a concave cover body coupled to the cover perimeter, and a cover knob medially coupled to the cover body, the cover perimeter being selectively engageable with the reservoir rim.

6. The frying oil filtration apparatus of claim 1 further comprising a cooling fan coupled to the housing, the cooling fan being coupled within the base portion and being in operational communication with the vacuum pump.

7. The frying oil filtration apparatus of claim 6 further comprising an underside of the base portion having a plurality of vent slots extending therethrough adjacent the cooling fan.

8. The frying oil filtration apparatus of claim 1 further comprising the reservoir bottom having a nipple extending around the fill aperture, the nipple selectively engaging the one-way valve.

9. A frying oil filtration apparatus comprising:
a housing having a base portion and a cylindrical sidewall extending from the base portion, the sidewall having a hose aperture extending therethrough, an underside of the base portion having a plurality of vent slots extending therethrough;
a plurality of feet coupled to the housing, each foot being coupled to the underside of the base portion;
a vacuum hose coupled to the housing, the vacuum hose being coupled to the hose aperture;
a filter coupled to the housing, the filter conforming to the cylindrical sidewall and having a reservoir cavity;
a collection pan coupled to the housing, the collection pan being coupled within the sidewall atop the base portion and beneath the filter, the collection pan having a release aperture;
a vacuum pump coupled to the housing, the vacuum pump being coupled within the base portion, the vacuum pump having a pump intake in fluid communication with the release aperture of the collection pan to create suction through the filter and the hose aperture, the vacuum pump having a pump output hose extending above the collection pan, the vacuum pump having a power cord extending through the housing;
a controller coupled to the housing, the controller being in operational communication with the vacuum pump, the controller having an adjustment knob and a plurality of indicator lights coupled to the base portion of the housing;
a cooling fan coupled to the housing, the cooling fan being coupled within the base portion adjacent the plurality of vent slots and being in operational communication with the vacuum pump;
a one-way valve coupled to the housing, the one-way valve being coupled adjacent the reservoir cavity of the filter and being in fluid communication with the pump output hose of the vacuum pump;
a reservoir, the reservoir having a reservoir bottom, a reservoir sidewall, and a reservoir rim, the reservoir bottom having a fill aperture extending therethrough and a nipple extending around the fill aperture, the reservoir sidewall conforming to the reservoir cavity of the filter to be selectively engageable within the filter, the nipple selectively engaging the one-way valve and the fill aperture being in fluid communication with the one-way valve to allow the reservoir to fill with filtered oil, the reservoir having a pair of reservoir handles coupled to the reservoir rim; and
a cover coupled to the reservoir, the cover including a cover perimeter, a concave cover body coupled to the cover perimeter, and a cover knob medially coupled to the cover body, the cover perimeter being selectively engageable with the reservoir rim.
